(19) United States
(12) Patent Application Publication
(10) Pub. No.: US 2026/0284685 A1
(43) Pub. Date: Sep. 24, 2026

(54) MASKING JIG AND SURFACE TREATMENT METHOD USING SAME

(71) Applicant: DYDO-TEC CORPORATION, Isesaki-shi (JP)

(72) Inventors: Masanao MURAOKA, Isesaki-shi (JP); Yutaka ISHII, Isesaki-shi (JP); Takuya KENMOCHI, Isesaki-shi (JP)

(21) Appl. No.: 19/469,960

(22) PCT Filed: Mar. 29, 2023
(86) PCT No.: PCT/JP2023/012878

§ 371 Date: Sep. 26, 2025

(51) Int. Cl. B05B 12/20

(52) U.S. Cl. CPC B05B 12/20

(57) ABSTRACT

A masking jig that can be attached to an object to be surface-treated with reliability without the need for causing a negative pressure in a space between the masking jig and the object to be surface-treated, and a surface treatment method using the same. A jig main body of a masking jig includes a first fitting part that is fitted into an inner peripheral face of a bearing part and a bushing of a moving scroll and a second fitting part that is fitted onto an outer peripheral face of the bearing part of the moving scroll, and therefore, the bearing part and the bushing of the moving scroll can be held between the first fitting part and the second fitting part fitted thereto, and the jig main body can be held on the moving scroll with reliability.

The present application is a U.S. National Phase of International Application Number PCT/JP2023/012878, filed Mar. 29, 2023.

### TECHNICAL FIELD

The present invention relates to a masking jig used when performing a surface treatment, such as plating or aluminum anodizing, on a component of various industrial products, for example, and a surface treatment method using the same.

### BACKGROUND ART

When performing a surface treatment on a component of various industrial products, the part that should not be subjected to the surface treatment is typically masked in the surface treatment. For example, a moving scroll, which is a component of a scroll compressor, has a bearing part having a cylindrical shape provided to protrude from the center of one end face thereof, and the other part than the bearing part or the other part than a predetermined range including the bearing part is subjected to the surface treatment. In such a process, it is known to attach a special masking jig to the component to mask the part that should not be subjected to the surface treatment with the masking jig (see Patent Literature 1, for example).

The masking jig is formed by an elastically deformable member having a seal part having a cylindrical shape that covers the outer peripheral face of the bearing part and a bottom part that covers one end of the bearing part, and once the masking jig is attached to the bearing part, a negative pressure is caused in the inner space of the bearing part sealed by the bottom part, thereby preventing the jig main body from easily coming off the component. In this case, the negative pressure in the inner space of the bearing part is caused by externally pressing the bottom part of the masking jig to push out the air in the inner space of the bearing part.

### CITATION LIST

### Patent Literature

Patent Literature 1: Japanese Patent No. 5194785

### SUMMARY OF INVENTION

### Technical Problem

However, the masking jig in the prior art example has a problem that an operation of pressing the bottom part of the masking jig to push out the inside air is needed, so that the number of operations increases, and if the operator fails to perform the operation, the masking jig attached to the component comes off. Furthermore, if a negative pressure is caused in the space between the masking jig and the object to be surface-treated, the liquid for surface treatment may be sucked into the bearing part when the bearing part is in the liquid.

The present invention has been devised in view of the problems described above, and an object of the present invention is to provide a masking jig that can be attached to an object to be surface-treated with reliability without the need for causing a negative pressure in a space between the masking jig and the object to be surface-treated, and a surface treatment method using the same.

### Solution to Problem

To attain the object described above, the present invention provides a masking jig that is attached to an object to be surface-treated having a cylindrical part that is open at one end and protrudes from the object and masks the object to be surface-treated with a jig main body configured to cover at least a surface of the cylindrical part of the object to be surface-treated, in which the jig main body includes a first fitting part having an outer peripheral face that is fitted into an inner peripheral face of the cylindrical part and a second fitting part having an inner peripheral face that is fitted onto an outer peripheral face of the cylindrical part.

Accordingly, when the jig main body is attached to the object to be surface-treated, the outer peripheral face of the first fitting part is fitted into the inner peripheral face of the cylindrical part, and the inner peripheral face of the second fitting part is fitted onto the outer peripheral face of the cylindrical part, so that the cylindrical part is held between the first fitting part and the second fitting part fitted thereto.

### Advantageous Effects of Invention

According to the present invention, since the cylindrical part is held between the first fitting part and the second fitting part fitted thereto, the jig main body can be held on the object to be surface-treated with reliability. Therefore, it is not necessary to cause a negative pressure in the space between the masking jig and the object to be surface-treated as in the prior art, and even if a vibration or impact is exerted, the masking jig can be effectively prevented from coming off the object to be surface-treated.

### BRIEF DESCRIPTION OF DRAWINGS

FIG. 1 is a plan view of a jig main body of a masking jig according to an embodiment of the present invention.

FIG. 2 is a bottom view of the jig main body.

FIG. 3 is a front view of the jig main body.

FIG. 4 is a perspective view of the masking jig and a moving scroll.

FIG. 5 is a side cross-sectional view showing an attachment step for the masking jig.

FIG. 6 is a side cross-sectional view showing the masking jig attached.

FIG. 7 is a plan view of a jig main body of a masking jig according to another embodiment of the present invention.

FIG. 8 is a bottom view of the jig main body.

FIG. 9 is a front view of the jig main body.

FIG. 10 is a plan view of a press-fitting member.

FIG. 11 is a bottom view of the press-fitting member.

FIG. 12 is a front view of the press-fitting member.

FIG. 13 is a side view of the press-fitting member.

FIG. 14 is a perspective view of the masking jig and the moving scroll.

FIG. 15 is a side cross-sectional view for illustrating an attachment process for the masking jig.

FIG. 16 is a side cross-sectional view for illustrating the attachment process for the masking jig.

FIG. 17 is a side cross-sectional view showing the masking jig attached.

### DESCRIPTION OF EMBODIMENTS

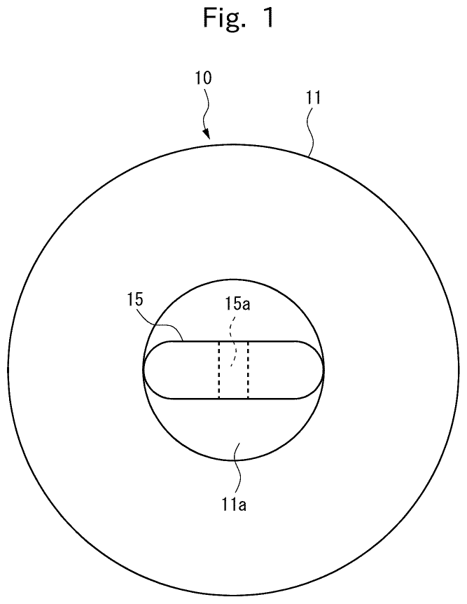

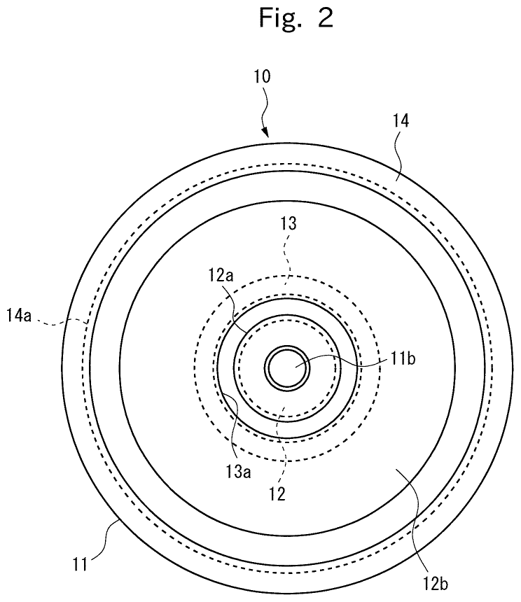

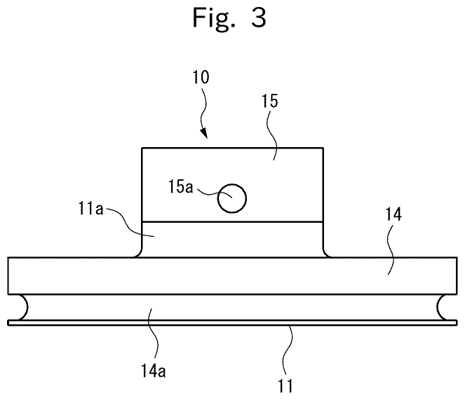

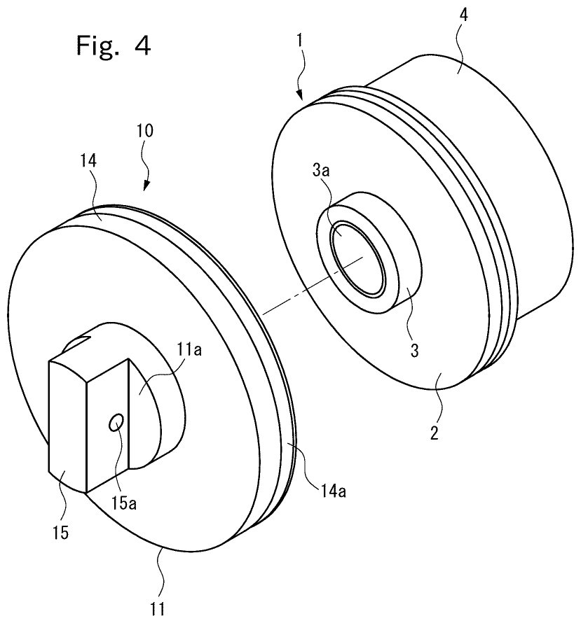

FIGS. 1 to 6 show an embodiment of the present invention, for example, a masking jig used in a surface treatment process of a moving scroll, which is a component of a scroll compressor.

In a moving scroll 1, which is an object to be surface-treated, shown in the drawings, a bearing part 3 having a cylindrical shape is provided on and protrudes from one end face of a main body part 2 having a disk shape, a bushing 3a having a cylindrical shape is attached to an inner peripheral face of the bearing part 3, and the bearing part 3 and the bushing 3a form a cylindrical part. The inside of the bearing part 3 is deeper than the one end face of the main body part 2, and an engaging part 3b formed by an annular recess is formed in a gap between one end in an axial direction of the bushing 3a and a bottom face of the bearing part 3. A scroll part 4 that is eccentric in a radial direction is provided on and protrudes from the other end face of the main body part 2, and an inner part of the scroll part 4 has a spiral configuration, although not shown in the drawings.

A masking jig 10 according to this embodiment includes a jig main body 11 formed to cover the moving scroll 1 on the side of the one end face, and the jig main body 11 is configured to be removably attached to the moving scroll 1.

The jig main body 11 is made of an elastically deformable material, such as rubber, and includes a first fitting part 12 that is fitted into the inner peripheral face of the bearing part 3 of the moving scroll 1, a second fitting part 13 that is fitted onto an outer peripheral face of the bearing part 3 of the moving scroll 1, a third fitting part 14 that is fitted onto an outer peripheral face of the main body part 2 of the moving scroll 1, and a grip part 15 that can be gripped with fingers. The third fitting part 14 is configured to be pressed against the outer peripheral face of the main body part 2 of the moving scroll 1 by an elastic ring 16, which is a ring-shaped member.

The jig main body 11 has a disk shape, and at a central part in the radial direction on one end face of the jig main body 11, a protrusion part 11a that protrudes to only one side in the axial direction (the side opposite to the face at which the jig main body 11 is attached to the moving scroll 1) is formed concentrically with the jig main body 11. In addition, a recess part 11b that is concentric with the jig main body 11 is provided in the other end face (the face at which the jig main body 11 is attached to the moving scroll 1) of the jig main body 11, and the recess part 11b has an outer diameter greater than the outer diameter of the protrusion part 11a.

The first fitting part 12 is provided to protrude concentrically with the jig main body 11 from the central part of the other end face of the jig main body 11 to the side opposite to the protrusion part 11a, and has a cylindrical shape having an outer diameter equal to the inner diameter of the bushing 3a of the bearing part 3 of the moving scroll 1 and a length slightly shorter than the depth of the bearing part 3 on the inner periphery side. At an edge of the first fitting part 12 on the tip end side, an engaging part 12a formed by an annular projection part that protrudes outward in the radial direction is formed, and the engaging part 12a is configured to be engaged with the engaging part 3b of the moving scroll 1. In addition, at a central part of the tip end face of the first fitting part 12, a recess part 12b that is concentric with the jig main body 11 is provided.

The second fitting part 13 is provided to protrude concentrically with the jig main body 11 from the other end face of the jig main body 11 to the side opposite to the protrusion part 11a, and is cylindrically formed at a distance from the first fitting part 12 in the radial direction. In this case, the second fitting part 13 has an inner diameter equal to the outer diameter of the bearing part 3 of the moving scroll 1 and a length equal to the height of the bearing part 3 on the outer periphery side. At an edge of the second fitting part 13 on the tip end side, a pressure contact part 13a formed by an annular projection part that protrudes inward in the radial direction is formed, and the pressure contact part 13a is configured to come into pressure contact with the outer peripheral face of the bearing part 3.

The third fitting part 14 is provided to protrude concentrically with the jig main body 11 from a peripheral edge of the jig main body 11 to the side opposite to the protrusion part 11a, and has a cylindrical shape having an inner diameter equal to the outer diameter of the main body part 2 of the moving scroll 1 and a length slightly shorter than the height of the main body part 2 on the outer periphery side. On an outer peripheral face of the third fitting part 14, an annular groove part 14a with which the elastic ring 16 is engaged is provided, and the groove part 14a has a substantially semicircular cross section.

The grip part 15 is provided to protrude from the protrusion part 11a to one side in the axial direction, and has a plate shape having two flat faces perpendicular to one end face of the protrusion part 11a. In addition, a through-hole 15a that penetrates the grip part 15 in a thickness direction is provided in the grip part 15, and the through-hole 15a is configured so that a hook for hanging (not shown) is inserted into the through-hole 15a.

The elastic ring 16 is an O-ring made of rubber, and is configured to press the third fitting part 14 against the outer peripheral face of the main body part 2 of the moving scroll 1 when the elastic ring 16 is mounted in the groove part 14a of the third fitting part 14.

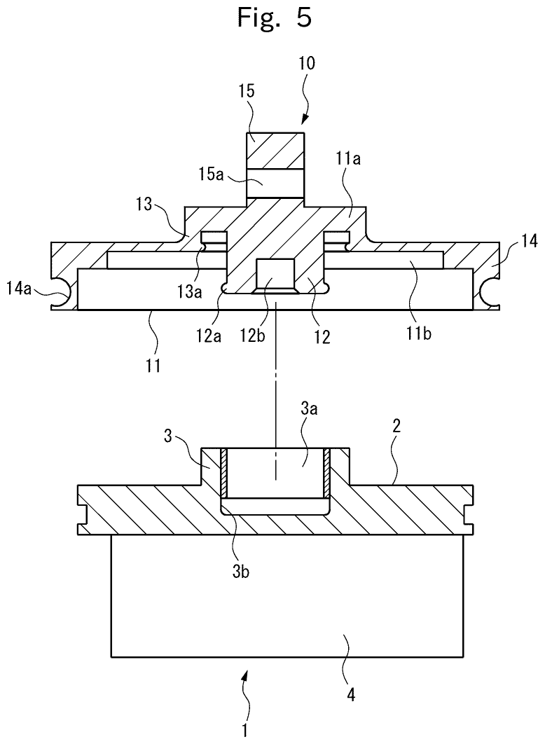

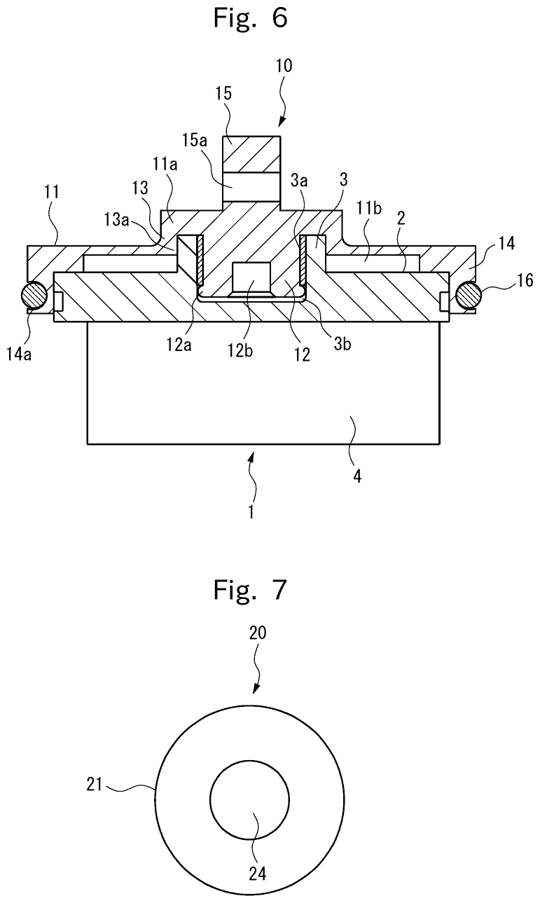

The masking jig 10 configured as described above is attached to the moving scroll 1 as shown in FIG. 6 by gripping the grip part 15 with fingers and pressing, against the one end face of the main body part 2 of the moving scroll 1, the jig main body 11 with the other end face thereof in the axial direction opposed to the one end face of the main body part 2 of the moving scroll 1 as shown in FIG. 5.

In this process, the first fitting part 12 of the jig main body 11 is inserted into the bearing part 3, the engaging part 12a of the first fitting part 12 is engaged with the engaging part 3b between the one end in the axial direction of the bushing 3a and the bottom face of the bearing part 3, and the first fitting part 12 is fitted into the inner peripheral face of the bushing 3a. In this case, the first fitting part 12 is elastically deformed inward in the radial direction while the engaging part 12a climbs over the bushing 3a and is engaged with the engaging part 3b, and the recess part 12b provided at the central part of the first fitting part 12 facilitates the elastic deformation of the first fitting part 12 in the radial direction.

Furthermore, in the attachment process described above, as the bearing part 3 is inserted into the second fitting part 13, the pressure contact part 13a of the second fitting part 13 is pressed against the outer peripheral face of the bearing part 3 and elastically deformed. In this way, the second fitting part 13 is fitted onto the outer peripheral face of the bearing part 3.

Furthermore, as the main body part 2 of the moving scroll 1 is inserted into the third fitting part 14, the third fitting part 14 is fitted onto the outer peripheral face of the main body part 2 of the moving scroll 1. In this process, a space is formed between the jig main body 11 and the one end face of the moving scroll 1 because of the recess part 11b. By attaching the elastic ring 16 to the third fitting part 14 in this state, the third fitting part 14 is pressed against the outer peripheral face of the main body part 2 of the moving scroll 1 to seal any gap between the jig main body 11 and the moving scroll 1.

After the masking jig 10 is attached to the moving scroll 1 as described above, a hook for hanging (not shown) is inserted into the through-hole 15a of the grip part 15 of the masking jig 10, and a surface treatment (such as plating) is performed on the moving scroll 1 masked with the masking jig 10 by immersing the moving scroll 1 in a liquid for surface treatment. In this process, even if a vibration or impact is exerted, since the bearing part 3 and the bushing 3a of the moving scroll 1 are held between the first fitting part 12 and the second fitting part 13 fitted thereto, the jig main body 11 is held on the moving scroll 1 with reliability without causing a negative pressure in the inner space of the bearing part as in the prior art.

As described above, the masking jig 10 according to this embodiment includes the first fitting part 12 that is fitted into the inner peripheral face of the bearing part 3 and the bushing 3a of the moving scroll 1 and the second fitting part 13 that is fitted onto the outer peripheral face of the bearing part 3 of the moving scroll 1, and the first fitting part 12 and the second fitting part 13 can be fitted to hold the bearing part 3 and the bushing 3a of the moving scroll 1 therebetween, so that the jig main body 11 can be held on the moving scroll 1 with reliability. Therefore, it is not necessary to cause a negative pressure in the space between the masking jig 10 and the object to be surface-treated as in the prior art, and even if a vibration or impact is exerted, the masking jig 10 can be effectively prevented from coming off the moving scroll 1.

Furthermore, since the elastic ring 16 that is removably attached to the third fitting part 14 of the jig main body 11 presses the third fitting part 14 against the outer peripheral face of the main body part 2 of the moving scroll 1, any gap between the jig main body 11 and the moving scroll 1 can be sealed with reliability, and entry of the liquid for surface treatment can be prevented with reliability.

Furthermore, since the jig main body 11 is provided with the grip part 15 that can be gripped with fingers, the first and second fitting parts 12 and 13 can be fitted to the bearing part 3 and the bushing 3a by gripping the grip part 15, so that the masking jig 10 can be easily attached to the moving scroll 1 with reliability.

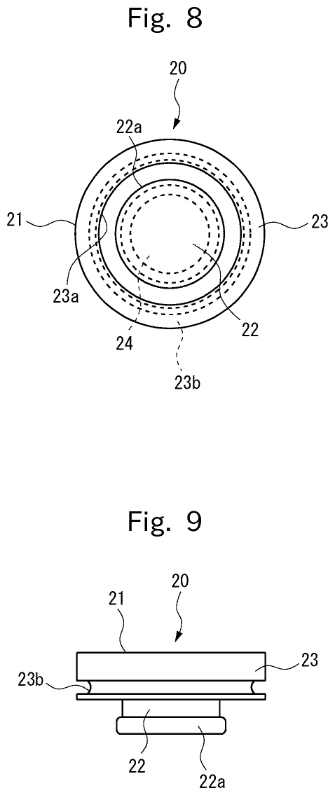

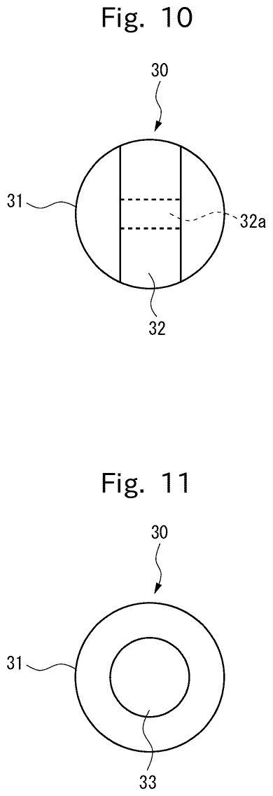

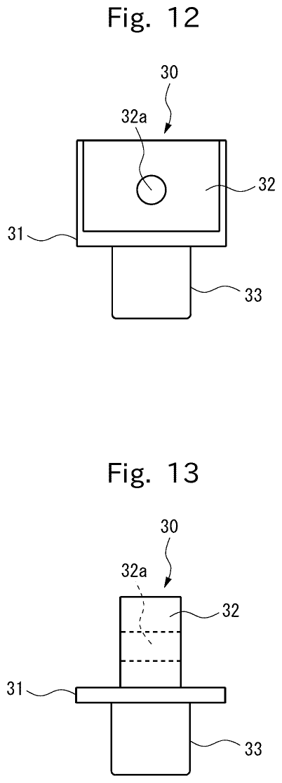

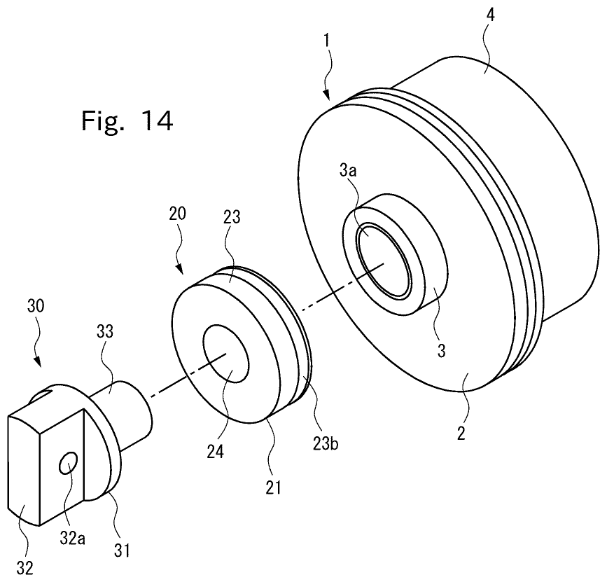

FIGS. 7 to 17 show another embodiment of the present invention. In these drawings, components equivalent to those in the embodiment described above are denoted by the same reference numerals.

A masking jig 20 according to this embodiment includes a jig main body 21 formed to cover the bearing part 3 of the moving scroll 1 and a press-fitting member 30 that is press-fitted into the jig main body 21, and the jig main body 21 is configured to be removably attached to the moving scroll 1.

The jig main body 21 is made of an elastically deformable material, such as rubber, and includes a first fitting part 22 that is fitted into the inner peripheral face of the bearing part 3 of the moving scroll 1, a second fitting part 23 that is fitted onto the outer peripheral face of the bearing part 3 of the moving scroll 1, and a recess part 24 into which the press-fitting member 30 is press-fitted. The second fitting part 23 is configured to be pressed against the outer peripheral face of the main body part 2 of the moving scroll 1 by an elastic ring 25, which is a ring-shaped member.

The jig main body 21 has a disk shape, and one end face (the face on the opposite side to the face at which the jig main body 21 is attached to the moving scroll 1) of the jig main body 21 is shaped to be a flat face.

The first fitting part 22 is provided to protrude concentrically with the jig main body 21 from the central part of the other end face of the jig main body 21 (the face at which the jig main body 21 is attached to the moving scroll 1), and has a cylindrical shape having an outer diameter equal to the inner diameter of the bushing 3a of the bearing part 3 of the moving scroll 1 and a length equal to the depth of the bearing part 3 on the inner periphery side. At an edge of the first fitting part 22 on the tip end side, an engaging part 22a formed by an annular projection part that protrudes outward in the radial direction is formed, and the engaging part 22a is configured to be engaged with the engaging part 3b of the moving scroll 1.

The second fitting part 23 is provided to protrude concentrically with the jig main body 11 from a peripheral edge of the jig main body 21 in the same direction as the first fitting part 22, and is cylindrically formed at a distance from the first fitting part 22 in the radial direction. In this case, the second fitting part 23 has an inner diameter equal to the outer diameter of the bearing part 3 of the moving scroll 1 and a length slightly shorter than the height of the bearing part 3 on the outer periphery side. At an edge of the second fitting part 23 on the tip end side, a pressure contact part 23a formed by an annular projection part that protrudes inward in the radial direction is formed, and the pressure contact part 23a is configured to come into pressure contact with the outer peripheral face f of the bearing part 3. Furthermore, on an outer peripheral face of the second fitting part 23, an annular groove part 23b with which the elastic ring 25 is engaged is provided, and the groove part 23b has a substantially semicircular cross section.

The recess part 24 is formed concentrically with the jig main body 21 and is provided in the first fitting part 22 in such a manner that one end of the recess part 24 opens in the one end face of the jig main body 21. Thus, the first fitting part 22 has a bottomed cylindrical shape having the recess part 24 therein.

The elastic ring 25 is an O-ring made of rubber, and is configured to press the second fitting part 23 against the outer peripheral face of the main body part 2 of the moving scroll 1 when the elastic ring 25 is mounted in the groove part 23b of the second fitting part 23.

The press-fitting member 30 is formed by a main body part 31 having a disk shape, a grip part 32 that can be gripped with fingers, and a projection part 33 that is press-fitted into the recess part 24 of the jig main body 21, and the main body part 31 has an outer diameter smaller than the outer diameter of the jig main body 21 and greater than the inner diameter of the recess part 24.

The grip part 32 is provided to protrude from the main body part 31 to one side in the axial direction, and has a plate shape having two flat faces perpendicular to one end face of the main body part 31. A through-hole 32a that penetrates the grip part 32 in a thickness direction is provided in the grip part 32, and the through-hole 32a is configured so that a hook for hanging (not shown) is inserted into the through-hole 32a.

The projection part 33 is provided to protrude from the main body part 31 to the other side in the axial direction, and has an outer diameter slightly greater than the inner diameter of the recess part 24 and a length equal to the depth of the recess part 24 on the inner periphery side.

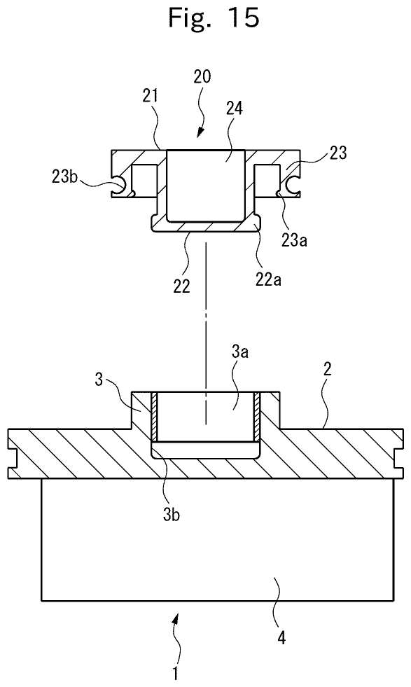

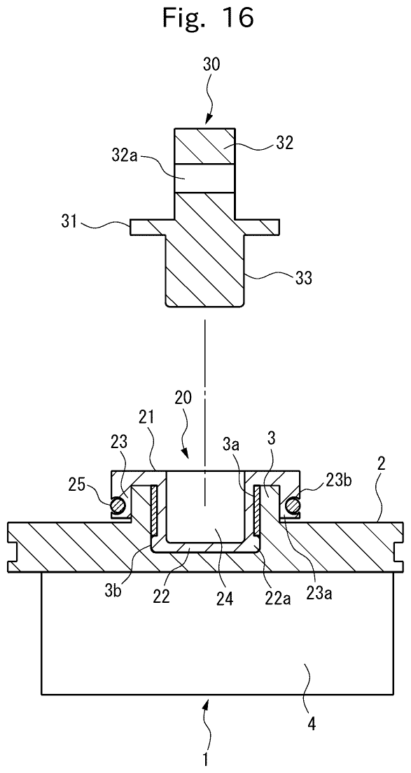

With the masking jig 20 configured as described above, the jig main body 21 is attached to the moving scroll 1 as shown in FIG. 16 with the other end face of the jig main body 21 in the axial direction opposed to the bearing part 3 of the moving scroll 1 as shown in FIG. 15.

In this process, the first fitting part 22 of the jig main body 21 is inserted into the bearing part 3, the engaging part 22a of the first fitting part 22 is engaged with the engaging part 3b between the one end in the axial direction of the bushing 3a and the bottom face of the bearing part 3, and the first fitting part 22 is fitted into the inner peripheral face of the bushing 3a. In this case, the first fitting part 22 is elastically deformed inward in the radial direction while the engaging part 22a climbs over the bushing 3a and is engaged with the engaging part 3b, and the recess part 24 provided in the first fitting part 22 facilitates the elastic deformation of the first fitting part 22 in the radial direction.

Furthermore, in the attachment process described above, as the bearing part 3 is inserted into the second fitting part 23, the pressure contact part 23a of the second fitting part 23 is pressed against the outer peripheral face of the bearing part 3 and elastically deformed. In this way, the second fitting part 23 is fitted onto the outer peripheral face of the bearing part 3. By attaching the elastic ring 25 to the second fitting part 23 in this state, the second fitting part 23 is pressed against the outer peripheral face of the bearing part 3 of the moving scroll 1 to seal any gap between the jig main body 21 and the moving scroll 1.

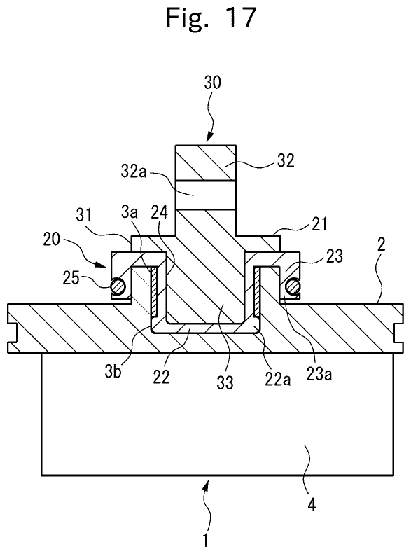

After the jig main body 21 is attached to the moving scroll 1, the press-fitting member 30 is attached to the jig main body 21 as shown in FIG. 16. In this process, the projection part 33 is press-fitted into the recess part 24 of the jig main body 21 by gripping the grip part 15 with fingers, and thus, the press-fitting member 30 is held in the jig main body 21 as shown in FIG. 17. As the press-fitting member 30 is press-fitted, the inner peripheral face of the recess part 24 is pressed in the radial direction by the projection part 33 of the press-fitting member 30, and the second fitting part 23 is in pressure contact with the inner peripheral face of the bearing part 3 and the bushing 3a.

After the masking jig 20 is attached to the moving scroll 1 as described above, a hook for hanging (not shown) is inserted into the through-hole 32a of the press-fitting member 30 of the masking jig 20, and a surface treatment (such as plating) is performed on the moving scroll 1 masked with the masking jig 20 by immersing the moving scroll 1 in a liquid for surface treatment. In this process, even if a vibration or impact is exerted, since the bearing part 3 and the bushing 3a of the moving scroll 1 are held between the first fitting part 22 and the second fitting part 23 fitted thereto, and the press-fitting member 30 press-fitted presses the outer peripheral face of the second fitting part 23 against the inner peripheral face of the bearing part 3 and the bushing 3a, the jig main body 21 is held on the moving scroll 1 with reliability without causing a negative pressure in the inner space of the bearing part as in the prior art.

As described above, the masking jig 20 according to this embodiment includes the first fitting part 22 that is fitted into the inner peripheral face of the bearing part 3 and the bushing 3a of the moving scroll 1 and the second fitting part 23 that is fitted onto the outer peripheral face of the bearing part 3 of the moving scroll 1 and further includes the press-fitting member 30 that is press-fitted into the recess part 24 provided in the second fitting part 23. Therefore, the bearing part 3 and the bushing 3a of the moving scroll 1 can be held between the first fitting part 22 and the second fitting part 23 fitted thereto, the press-fitting member 30 press-fitted can press the outer peripheral face of the second fitting part 23 against the inner peripheral face of the bearing part 3 and the bushing 3a, so that the jig main body 21 can be held on the moving scroll 1 with reliability. Therefore, it is not necessary to cause a negative pressure in the space between the masking jig 20 and the object to be surface-treated as in the prior art, and even if a vibration or impact is exerted, the masking jig 20 can be effectively prevented from coming off the moving scroll 1.

Furthermore, since the elastic ring 25 that is removably attached to the second fitting part 23 of the jig main body 21 presses the second fitting part 23 against the outer peripheral face of the main body part 2 of the moving scroll 1, any gap between the jig main body 21 and the moving scroll 1 can be sealed with reliability, and entry of the liquid for surface treatment can be prevented with reliability.

Furthermore, since the press-fitting member 30 is provided with the grip part 32 that can be gripped with fingers, the press-fitting member 30 can be press-fitted into the jig main body 21 by gripping the grip part 32, so that the press-fitting member 30 can be easily attached to the jig main body 21 with reliability.

Note that although in each of the embodiments described above, the engaging part 12a, 22a formed by an annular projection part provided on the masking jig 10, 20 is engaged with the engaging part 3b formed by an annular recess part formed inside the bearing part 3 of the moving scroll 1, such a recess part and a projection part may be omitted.

Furthermore, although in each of the embodiments described above, the elastic ring 16, 25 is used as a ring-shaped member, a ring-shaped member made of metal may be used.

Furthermore, although in each of the embodiments described above, the moving scroll 1, which is a component of a scroll compressor, is shown as the object to be surface-treated, the object to be surface-treated is not limited to the moving scroll, and the present invention can be applied to any object to be surface-treated that has a cylindrical part that is open at one end and protrudes from the object.

### Reference Signs List

1 moving scroll
3 bearing part
3a bushing
10 masking jig
11 jig main body
12 first fitting part
13 second fitting part
14 third fitting part
15 grip part
16 elastic ring
20 masking jig
21 jig main body
22 first fitting part
23 second fitting part
24 recess part
25 elastic ring
30 press-fitting member
32 grip part

1. A masking jig that is attached to an object to be surface-treated having a cylindrical part that is open at one end and protrudes from the object and masks the object to be surface-treated with a jig main body configured to cover at least a surface of the cylindrical part of the object to be surface-treated,
wherein the jig main body includes a first fitting part having an outer peripheral face that is fitted into an inner peripheral face of the cylindrical part and a second fitting part having an inner peripheral face that is fitted onto an outer peripheral face of the cylindrical part.

2. The masking jig according to claim 1, further comprising:
a ring-shaped member that is removably provided on a peripheral face of the jig main body and presses the jig main body against the object to be surface-treated.

3. The masking jig according to claim 1, wherein the jig main body has a grip part capable of being gripped with a finger and is configured so that the first fitting part and the second fitting part are fitted to the cylindrical part while gripping the grip part.

4. The masking jig according to claim 1, further comprising:
a press-fitting member capable of being press-fitted into a recess part provided in the first fitting part,
wherein the first fitting part is configured to be pressed toward the inner peripheral face of the cylindrical part by the press-fitting member press-fitted into the recess part.

5. The masking jig according to claim 4, wherein the press-fitting member has a grip part capable of being gripped with a finger and is configured to be press-fitted into the recess part while gripping the grip part.

6. A surface treatment method, wherein a surface treatment is performed by masking an object to be surface-treated with the masking jig according to claim 1.
